(19) United States
(12) Patent Application Publication
(10) Pub. No.: US 2014/0000273 A1
(43) Pub. Date: Jan. 2, 2014

(54) Low Emission Turbine Systems Incorporating Inlet Compressor Oxidant Control Apparatus And Methods Related Thereto

(71) Applicants: Franklin F. Mittricker, Jamul, CA (US); Richard A. Huntington, Houston, TX (US); Loren K. Starcher, Sugar Land, TX (US); Sulabh K. Dhanuka, Houston, TX (US); Omar Angus Sites, Spring, TX (US)

(72) Inventors: Franklin F. Mittricker, Jamul, CA (US); Richard A. Huntington, Houston, TX (US); Loren K. Starcher, Sugar Land, TX (US); Sulabh K. Dhanuka, Houston, TX (US); Omar Angus Sites, Spring, TX (US)

(21) Appl. No.: 14/002,621

(22) PCT Filed: Mar. 5, 2012
(86) PCT No.: PCT/US12/27769

§ 371 Date: Aug. 30, 2013

Related U.S. Application Data
(60) Provisional application No. 61/542,030, filed on Sep. 30, 2011.
(60) Provisional application No. 61/466,384, filed on Mar. 22, 2011.

(51) Int. Cl. F02C 3/20

(52) U.S. Cl. CPC F02C 3/20
USPC 60/773; 60/39.19

(57) ABSTRACT

Systems, methods, and apparatus are provided for controlling the oxidant feed in low emission turbine systems to maintain stoichiometric or substantially stoichiometric combustion conditions. In one or more embodiments, such control is achieved through methods or systems that ensure delivery of a consistent mass flow rate of oxidant to the combustion chamber.

### CROSS REFERENCE TO RELATED APPLICATIONS

This application claims priority to U.S. Provisional Application 61/466,384 filed Mar. 22, 2011 entitled, LOW EMISSION TURBINE SYSTEMS HAVING A MAIN AIR COMPRESSOR OXIDANT CONTROL APPARATUS AND METHODS RELATED THERETO; and U.S. Provisional Application 61/542,030 filed Sep. 30, 2011 entitled, LOW EMISSION TURBINE SYSTEMS INCORPORATING INLET COMPRESSOR OXIDANT CONTROL APPARATUS AND METHODS RELATED THERETO; both of which are hereby incorporated by reference in their entirety.

This application is related to U.S. Provisional Application 61/542,036 filed Sep. 30, 2011 entitled, SYSTEMS AND METHODS FOR CARBON DIOXIDE CAPTURE IN LOW EMISSION TURBINE SYSTEMS; U.S. Provisional Application 61/542,037 filed Sep. 30, 2011 entitled, SYSTEMS AND METHODS FOR CARBON DIOXIDE CAPTURE IN LOW EMISSION TURBINE SYSTEMS; U.S. Provisional Application 61/542,039 filed Sep. 30, 2011 entitled, SYSTEMS AND METHODS FOR CARBON DIOXIDE CAPTURE IN LOW EMISSION COMBINED TURBINE SYSTEMS; U.S. Provisional Application 61/542,041 filed Sep. 30, 2011 entitled, LOW EMISSION POWER GENERATION SYSTEMS AND METHODS INCORPORATING CARBON DIOXIDE SEPARATION; U.S. Provisional Application 61/466,381 filed Mar. 22, 2011 entitled, METHODS OF VARYING LOW EMISSION TURBINE GAS RECYCLE CIRCUITS AND SYSTEMS AND APPARATUS RELATED THERETO; U.S. Provisional Application 61/542,035 filed Sep. 30, 2011 entitled, METHODS OF VARYING LOW EMISSION TURBINE GAS RECYCLE CIRCUITS AND SYSTEMS AND APPARATUS RELATED THERETO; U.S. Provisional Application 61/466,385 filed Mar. 22, 2011 entitled, METHODS FOR CONTROLLING STOICHIOMETRIC COMBUSTION ON A FIXED GEOMETRY GAS TURBINE SYSTEM AND APPARATUS AND SYSTEMS RELATED THERETO; U.S. Provisional Application 61/542,031 filed Sep. 30, 2011 entitled, SYSTEMS AND METHODS FOR CONTROLLING STOICHIOMETRIC COMBUSTION IN LOW EMISSION TURBINE SYSTEMS; all of which are hereby incorporated by reference in their entirety.

### FIELD OF THE DISCLOSURE

Embodiments of the disclosure relate to low emission power generation. More particularly, embodiments of the disclosure relate to methods and apparatus for controlling the supply of oxidant to the combustion chamber of a low emission turbine system to achieve and maintain stoichiometric or substantially stoichiometric combustion conditions.

### BACKGROUND OF THE DISCLOSURE

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Many oil producing countries are experiencing strong domestic growth in power demand and have an interest in enhanced oil recovery (EOR) to improve oil recovery from their reservoirs. Two common EOR techniques include nitrogen (N₂) injection for reservoir pressure maintenance and carbon dioxide (CO₂) injection for miscible flooding for EOR. There is also a global concern regarding green house gas (GHG) emissions. This concern combined with the implementation of cap-and-trade policies in many countries makes reducing CO₂ emissions a priority for those countries as well as for the companies that operate hydrocarbon production systems therein.

Some approaches to lower CO₂ emissions include fuel de-carbonization or post-combustion capture using solvents, such as amines. However, both of these solutions are expensive and reduce power generation efficiency, resulting in lower power production, increased fuel demand and increased cost of electricity to meet domestic power demand. In particular, the presence of oxygen, SO_{X}, and NO_{X} components makes the use of amine solvent absorption very problematic. Another approach is an oxyfuel gas turbine in a combined cycle (e.g., where exhaust heat from the gas turbine Brayton cycle is captured to make steam and produce additional power in a Rankin cycle). However, there are no commercially available gas turbines that can operate in such a cycle and the power required to produce high purity oxygen significantly reduces the overall efficiency of the process.

Moreover, with the growing concern about global climate change and the impact of carbon dioxide emissions, emphasis has been placed on minimizing carbon dioxide emissions from power plants. Gas turbine combined cycle power plants are efficient and have a lower cost compared to nuclear or coal power generation technologies. Capturing carbon dioxide from the exhaust of a gas turbine combined cycle power plant is very expensive for the following reasons: (a) the low concentration of carbon dioxide in the exhaust stack, (b) the large volume of gas that needs to be treated, (c) the low pressure of the exhaust stream, and the large amount of oxygen that is present in the exhaust stream. All of these factors result in a high cost of carbon dioxide capture from combined cycle plants.

Accordingly, there is still a substantial need for a low emission, high efficiency power generation and CO₂ capture manufacturing process.

### SUMMARY OF THE DISCLOSURE

In the combined cycle power plants described herein, exhaust gases from low emission gas turbines, which are vented in a typical natural gas combined cycle (NGCC) plant, are instead cooled and recycled to the gas turbine main compressor inlet. The recycle exhaust gases, rather than excess compressed fresh air, are used to cool the products of combustion down to the material limitations in the expander. The present apparatus, systems, and methods enable low emission turbines to maintain a preferred combustion regime, e.g., stoichiometric combustion, over a large range of ambient conditions. By combining stoichiometric combustion with exhaust gas recycle, the concentration of CO₂ in the recirculating gases is increased while minimizing the presence of excess O₂, both of which make CO₂ recovery easier. In one or more embodiments, the low emission turbine systems described herein employ air as the oxidant.

The present invention is directed to systems, methods, and apparatus for controlling the oxidant feed in low emission turbine systems so as to maintain stoichiometric or substantially stoichiometric combustion conditions. In one or more embodiments, such control is achieved through methods or systems that ensure delivery of a consistent mass flow rate of oxidant to the combustion chamber. Examples include, but are not limited to, methods and systems for chilling the oxidant feed to maintain a constant temperature (and therefore density and volume), using a blower with a variable frequency drive to maintain a constant density of the oxidant feed, and using inlet guide vanes on the inlet compressor to maintain a constant volume of oxidant fed to the combustion chamber.

### BRIEF DESCRIPTION OF THE DRAWINGS

The foregoing and other advantages of the present disclosure may become apparent upon reviewing the following detailed description and drawings of non-limiting examples of embodiments in which:

FIG. 1 depicts an integrated system for low emission power generation and enhanced CO₂ recovery.

FIG. 2 depicts an integrated system for low emission power generation and enhanced CO₂ recovery in which the oxidant feed is chilled prior to entering the inlet compressor.

FIG. 3 depicts an integrated system for low emission power generation and enhanced CO₂ recovery in which a blower with a variable frequency drive is used to maintain the density of the oxidant feed to the inlet compressor.

FIG. 4 depicts an integrated system for low emission power generation and enhanced CO₂ recovery incorporating inlet guide vanes and a blowdown valve on the inlet compressor.

### DETAILED DESCRIPTION

In the following detailed description section, the specific embodiments of the present disclosure are described in connection with preferred embodiments. However, to the extent that the following description is specific to a particular embodiment or a particular use of the present disclosure, this is intended to be for exemplary purposes only and simply provides a description of the exemplary embodiments. Accordingly, the disclosure is not limited to the specific embodiments described below, but rather, it includes all alternatives, modifications, and equivalents falling within the true spirit and scope of the appended claims.

Various terms as used herein are defined below. To the extent a term used in a claim is not defined below, it should be given the broadest definition persons in the pertinent art have given that term as reflected in at least one printed publication or issued patent.

As used herein, the term “natural gas” refers to a multi-component gas obtained from a crude oil well (associated gas) and/or from a subterranean gas-bearing formation (non-associated gas). The composition and pressure of natural gas can vary significantly. A typical natural gas stream contains methane (CH₄) as a major component, i.e. greater than 50 mol % of the natural gas stream is methane. The natural gas stream can also contain ethane (C₂H₆), higher molecular weight hydrocarbons (e.g., C₃-C₂₀ hydrocarbons), one or more acid gases (e.g., hydrogen sulfide), or any combination thereof. The natural gas can also contain minor amounts of contaminants such as water, nitrogen, iron sulfide, wax, crude oil, or any combination thereof.

As used herein, the term “stoichiometric combustion” refers to a combustion reaction having a volume of reactants comprising a fuel and an oxidizer and a volume of products formed by combusting the reactants where the entire volume of the reactants is used to form the products. As used herein, the term “substantially stoichiometric” combustion refers to a combustion reaction having an equivalence ratio ranging from about 0.9:1 to about 1.1:1, or more preferably from about 0.95:1 to about 1.05:1. Use of the term “stoichiometric” herein is meant to encompass both stoichiometric and substantially stoichiometric conditions unless otherwise indicated.

As used herein, the term “stream” refers to a volume of fluids, although use of the term stream typically means a moving volume of fluids (e.g., having a velocity or mass flow rate). The term “stream,” however, does not require a velocity, mass flow rate, or a particular type of conduit for enclosing the stream.

Embodiments of the presently disclosed systems and processes may be used to produce ultra low emission electric power and CO₂ for enhanced oil recovery (EOR) or sequestration applications. According to embodiments disclosed herein, a mixture of air and fuel can be stoichiometrically combusted and simultaneously mixed with a stream of recycled exhaust gas. The stream of recycled exhaust gas, generally including products of combustion such as CO₂, can be used as a diluent to control or otherwise moderate the temperature of the stoichiometric combustion and flue gas entering the succeeding expander.

Combustion at near stoichiometric conditions (or “slightly rich” combustion) can prove advantageous in order to eliminate the cost of excess oxygen removal. By cooling the flue gas and condensing the water out of the stream, a relatively high content CO₂ stream can be produced. While a portion of the recycled exhaust gas can be utilized for temperature moderation in a closed Brayton cycle, the remaining purge stream can be used for EOR applications and electric power can be produced with little or no SO_{X}, NO_{X}, or CO₂ being emitted to the atmosphere. For example, the purge stream can be treated in a CO₂ separator adapted to discharge a nitrogen-rich gas which can be subsequently expanded in a gas expander to generate additional mechanical power. The result of the systems disclosed herein is the production of power and the manufacturing or capture of additional CO₂ at a more economically efficient level. In order to avoid deviations from stoichiometric conditions, however, the amount of oxidant supplied to the combustor must be closely controlled. The present invention provides systems and methods for achieving such control.

In one or more embodiments, the present invention is directed to integrated systems comprising an inlet compressor, a gas turbine system, and an exhaust gas recirculation system. The gas turbine system comprises a combustion chamber configured to combust one or more oxidants and one or more fuels in the presence of a compressed recycle stream. The inlet compressor compresses the one or more oxidants and directs a compressed oxidant stream to the combustion chamber, where the reaction conditions for combustion are stoichiometric or substantially stoichiometric. The combustion chamber directs a first discharge stream to an expander to generate a gaseous exhaust stream and at least partially drive a main compressor, and the main compressor compresses the gaseous exhaust stream and thereby generates the compressed recycle stream.

In one or more embodiments, the system further comprises one or more cooling devices configured to cool the one or more oxidants before introduction to the inlet compressor. For example, the oxidant may be cooled to a temperature that is at least about 5° F., or at least about 10° F., or at least about 15° F., or at least about 20° F., or at least about 25° F., or at least about 30° F., or at least about 35° F., or at least about 40° F. lower than the ambient air temperature. In the same or other embodiments, the temperature difference between the oxidant entering the cooling device and the oxidant exiting the cooling device is at least about 5° F., or at least about 10° F., or at least about 15° F., or at least about 20° F., or at least about 25° F., or at least about 30° F., or at least about 35° F., or at least about 40° F. In one or more embodiments, the cooling device may be one or more heat exchangers, mechanical refrigeration units, direct contact coolers, trim coolers, or similar devices and combinations thereof. Additionally, the cooling device may employ any known cooling fluid suitable for such applications, such as chilled water or seawater, or refrigerants such as for example non-halogenated hydrocarbons, fluorocarbons, hydrofluorocarbons, chlorofluorocarbons, hydrochlorofluorocarbons, anhydrous ammonia, propane, carbon dioxide, propylene, and the like. In certain embodiments, the system may further comprise a separator configured to receive cooled oxidant from the cooling device and remove any water droplets from the oxidant stream before introduction to the inlet compressor. The separator may be any device suitable for the intended use, such as for example a vane pack, mesh pad, or other demisting device.

In the same or other embodiments, the integrated systems of the present invention may comprise a blower configured to increase the pressure of the one or more oxidants before introduction to the inlet compressor. In certain embodiments, the blower may be controlled by a variable frequency driver.

In further embodiments of the present invention, the inlet compressor comprises inlet guide vanes. The inlet guide vanes may be stationary or adjustable. In one or more embodiments, the inlet guide vanes are adjustable. In the same or other embodiments, the inlet compressor may further comprise a vent stream configured to release excess oxidant from the inlet compressor. The vent stream may incorporate a valve or other device configured to allow varying flow of the vent stream, such as for example a blowdown valve.

In one or more embodiments, the present invention also provides methods for generating power. The methods comprise compressing one or more oxidants in an inlet compressor to form a compressed oxidant; combusting the compressed oxidant and at least one fuel in a combustion chamber in the presence of a compressed recycle exhaust gas and under stoichiometric or substantially stoichiometric conditions, thereby generating a discharge stream; expanding the discharge stream in an expander to at least partially drive a main compressor and generate a gaseous exhaust stream; and directing the gaseous exhaust stream to an exhaust gas recirculation system. The main compressor compresses the gaseous exhaust stream and thereby generates the compressed recycle stream.

In one or more embodiments, methods of the present invention further comprise cooling the one or more oxidants with a cooling device before introducing the one or more oxidants to the inlet compressor. For example, the oxidant may be cooled to a temperature that is at least about 5° F., or at least about 10° F., or at least about 15° F., or at least about 20° F., or at least about 25° F., or at least about 30° F., or at least about 35° F., or at least about 40° F. lower than the ambient air temperature. In the same or other embodiments, the temperature difference between the oxidant entering the cooling device and the oxidant exiting the cooling device is at least about 5° F., or at least about 10° F., or at least about 15° F., or at least about 20° F., or at least about 25° F., or at least about 30° F., or at least about 35° F., or at least about 40° F. In the same or other embodiments, methods of the invention further comprise receiving cooled oxidant from the cooling device and removing water droplets from the cooled oxidant in a separator before introducing the oxidant to the inlet compressor.

In one or more embodiments, methods of the invention further comprise increasing the pressure of the one or more oxidants using a blower before introducing the oxidant to the inlet compressor. The blower may be controlled by a variable frequency driver.

In one or more embodiments, the inlet compressor may comprise inlet guide vanes. In the same or other embodiments, methods of the invention may further comprise venting excess oxidant from the inlet compressor, such as by a vent stream comprising a blowdown valve.

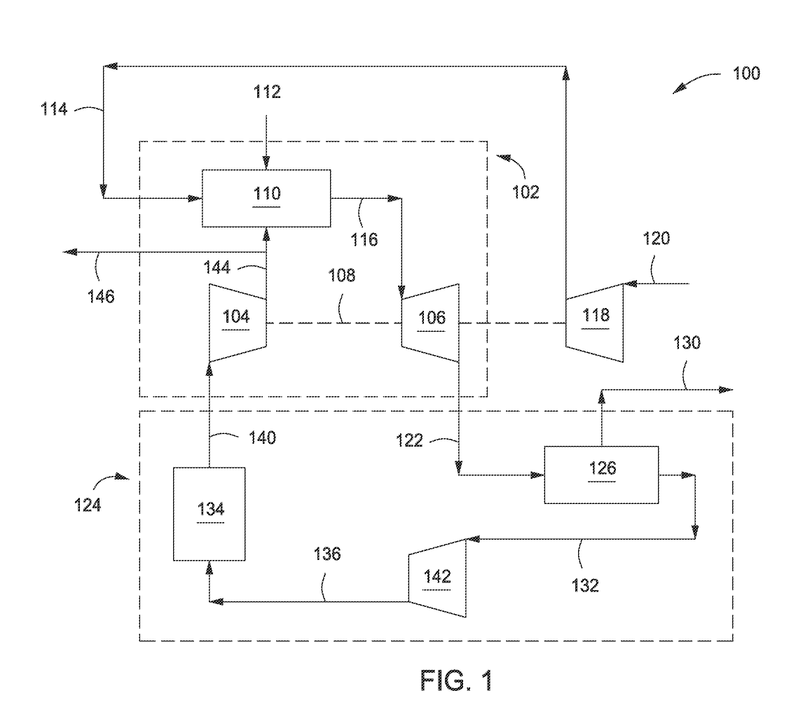

Referring now to the figures, various embodiments of the present invention may be best understood with reference to a base case, shown in FIG. 1. FIG. 1 illustrates a power generation system 100 configured to provide an improved post-combustion CO₂ capture process. In at least one embodiment, the power generation system 100 can include a gas turbine system 102 that can be characterized as a closed Brayton cycle. In one embodiment, the gas turbine system 102 can have a first or main compressor 104 coupled to an expander 106 through a common shaft 108 or other mechanical, electrical, or other power coupling, thereby allowing a portion of the mechanical energy generated by the expander 106 to drive the compressor 104. The expander 106 may generate power for other uses as well, such as to power a second or inlet compressor 118. The gas turbine system 102 can be a standard gas turbine, where the main compressor 104 and expander 106 form the compressor and expander ends, respectively, of the standard gas turbine. In other embodiments, however, the main compressor 104 and expander 106 can be individualized components in a system 102.

The gas turbine system 102 can also include a combustion chamber 110 configured to combust a fuel stream 112 mixed with a compressed oxidant 114. In one or more embodiments, the fuel stream 112 can include any suitable hydrocarbon gas or liquid, such as natural gas, methane, naphtha, butane, propane, syngas, diesel, kerosene, aviation fuel, coal derived fuel, bio-fuel, oxygenated hydrocarbon feedstock, or combinations thereof.

The compressed oxidant 114 can be derived from a second or inlet compressor 118 fluidly coupled to the combustion chamber 110 and adapted to compress a feed oxidant 120. While the discussion herein assumes that the feed oxidant 120 is ambient air, the oxidant may comprise any suitable gas containing oxygen, such as air, oxygen-rich air, or combinations thereof.

As will be described in more detail below, the combustion chamber 110 can also receive a compressed recycle stream 144, including a flue gas primarily having CO₂ and nitrogen components. The compressed recycle stream 144 can be derived from the main compressor 104 and adapted to help facilitate the combustion of the compressed oxidant 114 and fuel 112, and also increase the CO₂ concentration in the working fluid. A discharge stream 116 directed to the inlet of the expander 106 can be generated as a product of combustion of the fuel stream 112 and the compressed oxidant 114, in the presence of the compressed recycle stream 144. In at least one embodiment, the fuel stream 112 can be primarily natural gas, thereby generating a discharge 116 including volumetric portions of vaporized water, CO₂, nitrogen, nitrogen oxides (NO_{X}), and sulfur oxides (SO_{X}). In some embodiments, a small portion of unburned fuel 112 or other compounds may also be present in the discharge 116 due to combustion equilibrium limitations. As the discharge stream 116 expands through the expander 106 it generates mechanical power to drive the main compressor 104, or other facilities, and also produces a gaseous exhaust stream 122 having a heightened CO₂ content.

The power generation system 100 can also include an exhaust gas recirculation (EGR) system 124. While the EGR system 124 illustrated in the figures incorporates various apparatus, the illustrated configurations are representative only and any system that recirculates the exhaust gas 122 back to the main compressor to accomplish the goals stated herein may be used. In one or more embodiments, the EGR system 124 can include a heat recovery steam generator (HRSG) 126, or similar device. The gaseous exhaust stream 122 can be sent to the HRSG 126 in order to generate a stream of steam 130 and a cooled exhaust gas 132. The steam 130 can optionally be sent to a steam gas turbine (not shown) to generate additional electrical power. In such configurations, the combination of the HRSG 126 and the steam gas turbine can be characterized as a closed Rankine cycle. In combination with the gas turbine system 102, the HRSG 126 and the steam gas turbine can form part of a combined-cycle power generating plant, such as a natural gas combined-cycle (NGCC) plant.

In one or more embodiments, the cooled exhaust gas 132 exiting the HRSG 126 may be sent to at least one cooling unit 134 configured to reduce the temperature of the cooled exhaust gas 132 and generate a cooled recycle gas stream 140. In one or more embodiments, the cooling unit 134 is considered herein to be a direct contact cooler (DCC), but may be any suitable cooling device such as a direct contact cooler, trim cooler, a mechanical refrigeration unit, or combinations thereof. The cooling unit 134 can also be configured to remove a portion of condensed water via a water dropout stream (not shown). In one or more embodiments, the cooled exhaust gas stream 132 can be directed to a blower or boost compressor 142 fluidly coupled to the cooling unit 134. In such embodiments, compressed exhaust gas stream 136 exits the blower 142 and is directed to the cooling unit 134.

The blower 142 can be configured to increase the pressure of the cooled exhaust gas stream 132 before it is introduced into the main compressor 104. In one or more embodiments, the blower 142 increases the overall density of the cooled exhaust gas stream 132, thereby directing an increased mass flow rate for the same volumetric flow to the main compressor 104. Because the main compressor 104 is typically volume-flow limited, directing more mass flow through the main compressor 104 can result in a higher discharge pressure from the main compressor 104, thereby translating into a higher pressure ratio across the expander 106. A higher pressure ratio generated across the expander 106 can allow for higher inlet temperatures and, therefore, an increase in expander 106 power and efficiency. This can prove advantageous since the CO₂-rich discharge 116 generally maintains a higher specific heat capacity. Accordingly, the cooling unit 134 and the blower 142, when incorporated, may each be adapted to optimize or improve the operation of the gas turbine system 102.

The main compressor 104 can be configured to compress the cooled recycle gas stream 140 received from the EGR system 124 to a pressure nominally above the combustion chamber 110 pressure, thereby generating the compressed recycle stream 144. In at least one embodiment, a purge stream 146 can be tapped from the compressed recycle stream 144 and subsequently treated in a CO₂ separator or other apparatus (not shown) to capture CO₂. The separated CO₂ can be used for sales, used in another process requiring carbon dioxide, and/or compressed and injected into a terrestrial reservoir for enhanced oil recovery (EOR), sequestration, or another purpose.

The EGR system 124 as described herein can be implemented to achieve a higher concentration of CO₂ in the working fluid of the power generation system 100, thereby allowing for more effective CO₂ separation for subsequent sequestration, pressure maintenance, or EOR applications. For instance, embodiments disclosed herein can effectively increase the concentration of CO₂ in the flue gas exhaust stream to about 10 wt % or higher. To accomplish this, the combustion chamber 110 is adapted to stoichiometrically combust the incoming mixture of fuel 112 and compressed oxidant 114. In order to moderate the temperature of the stoichiometric combustion to meet expander 106 inlet temperature and component cooling requirements, a portion of the exhaust gas derived from the compressed recycle stream 144 can be injected into the combustion chamber 110 as a diluent. Thus, embodiments of the disclosure can essentially eliminate any excess oxygen from the working fluid while simultaneously increasing its CO₂ composition. As such, the gaseous exhaust stream 122 can have less than about 3.0 vol % oxygen, or less than about 1.0 vol % oxygen, or less than about 0.1 vol % oxygen, or even less than about 0.001 vol % oxygen.

In some embodiments not depicted herein, high pressure steam may also be employed as a diluent in the combustion chamber, either in place of or in addition to the recycled exhaust gas. In such embodiments, the addition of steam would reduce power and size requirements in the EGR system (or eliminate the EGR system altogether), but would require the addition of a water recycle loop.

Additionally, in further embodiments not depicted herein, the compressed oxidant feed to the combustion chamber may comprise argon. For example, the oxidant may comprise from about 0.1 to about 5.0 vol % argon, or from about 1.0 to about 4.5 vol % argon, or from about 2.0 to about 4.0 vol % argon, or from about 2.5 to about 3.5 vol % argon, or about 3.0 vol % argon. As will be appreciated by those skilled in the art, incorporating argon into the compressed oxidant feed may require the addition of a cross exchanger or similar device between the main compressor and the combustion chamber configured to remove excess CO₂ from the recycle stream and return argon to the combustion chamber at the appropriate temperature for combustion.

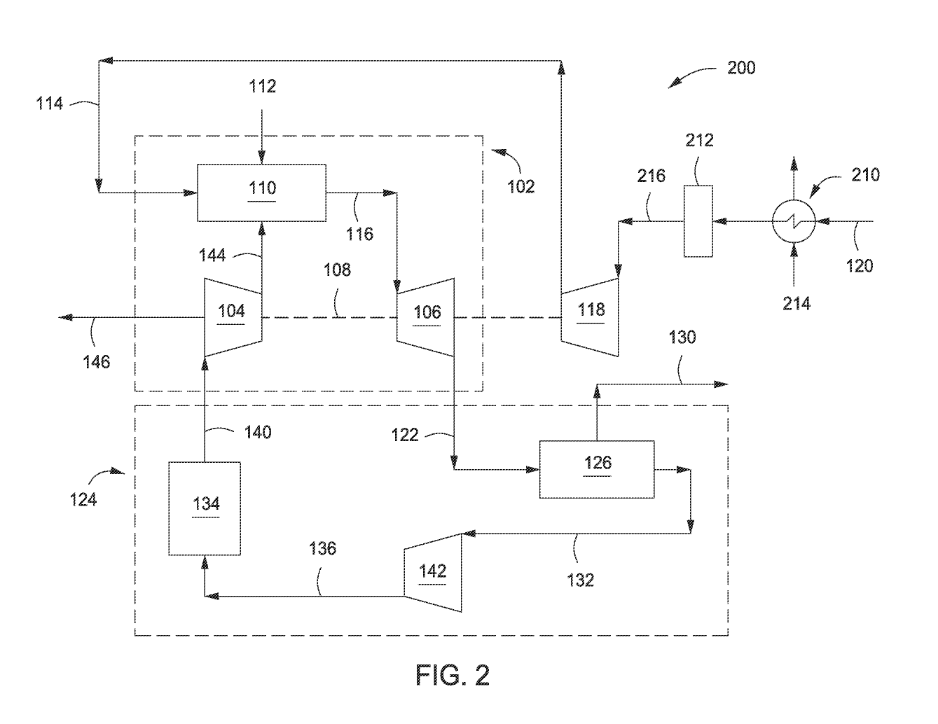

FIGS. 2 through 4 illustrate modifications to the reference system 100 depicted in FIG. 1 that are intended to allow more precise control over the amount of oxidant fed to the combustion chamber 110. Increased control over the oxidant feed allows for consistent maintenance of stoichiometric combustion conditions regardless of variations elsewhere in the system or in the outside environment.

Referring now to FIG. 2, depicted is an alternative embodiment of the power generation system 100 of FIG. 1, embodied and described as system 200. As such, FIG. 2 may be best understood with reference to FIG. 1. In system 200 of FIG. 2, the feed oxidant 120 is chilled before being fed to the inlet compressor 118. The mass of oxidant exiting the inlet compressor 118 is largely determined by the density of the oxidant feed entering the inlet compressor 118. With a fixed inlet geometry, the inlet compressor 118 generally pulls in a fixed volume of gas. By controlling the temperature of the oxidant feed 120, its density can be controlled, which in turn means that at a constant volume the mass flow rate of the oxidant feed is also controlled. When the mass flow rate of the oxidant feed 120 to the combustion chamber 110 is constant, stoichiometric conditions can be maintained more easily. As shown in FIG. 2, the oxidant feed 120 is chilled in a heat exchanger 210 upstream of the inlet compressor 118. Cooling of the oxidant feed 120 is accomplished by a refrigerant, provided in stream 214. While a heat exchanger employing a refrigerant is depicted herein, any type of cooling device may be employed to cool the oxidant to the desired temperature. For example, other methods of cooling include one or more heat exchangers using chilled water or seawater as the cooling fluid, mechanical refrigeration units, direct contact coolers, trim coolers, and combinations thereof. Additionally, any known refrigerant suitable for the intended use may be employed, such as for example non-halogenated hydrocarbons, fluorocarbons, hydrofluorocarbons, chlorofluorocarbons, hydrochlorofluorocarbons, anhydrous ammonia, propane, carbon dioxide, propylene, and the like. Further, although one heat exchanger 210 is depicted in FIG. 2, two or more heat exchangers or other cooling devices may be employed (not shown), particularly in conjunction with multi-stage compressors. In such embodiments, it may be desirable to incorporate one or more cooling devices between each stage of the compressor.

In one or more embodiments of the present invention, the chilled oxidant feed 120 exiting the heat exchanger 210 may optionally be directed to a separator 212 to remove any condensed water droplets that may be entrained therein. Separator 212 can be any device suitable for the removal of water droplets, such as for example a vane pack, mesh pad, or other demisting device. From the separator 212, the oxidant feed stream 120 is directed to the inlet compressor 118, and the remainder of the system 200 operates in the same fashion as the system 100 of FIG. 1 described previously.

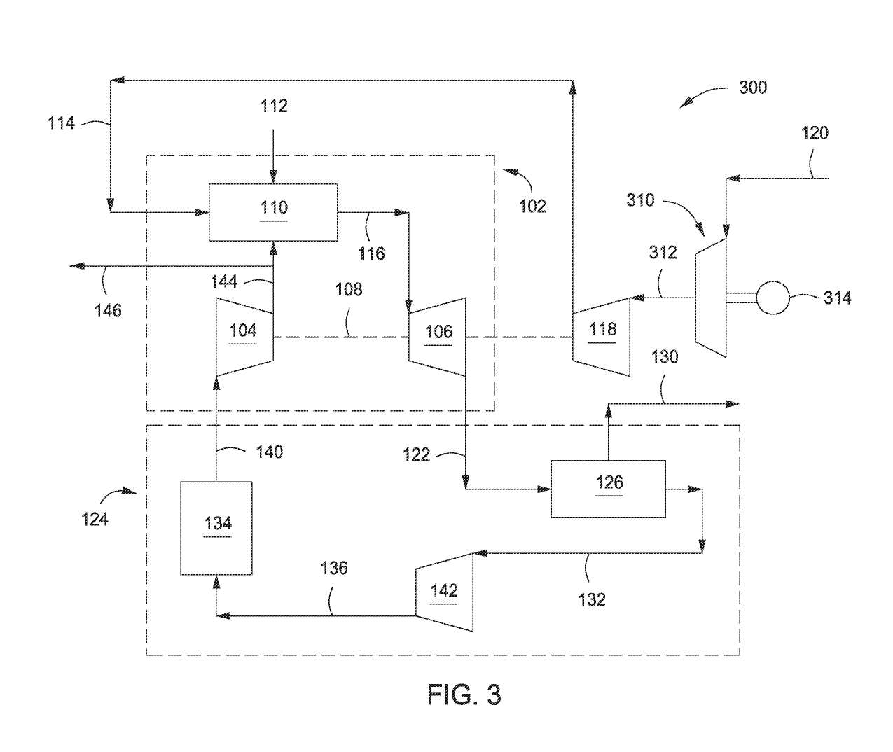

Referring now to FIG. 3, depicted is an alternative configuration of the power generation system 100 of FIG. 1, embodied and described as system 300. As such, FIG. 3 may be best understood with reference to FIG. 1. In system 300 of FIG. 3, the pressure of the feed oxidant 120 is boosted by a blower 310 before being fed to the inlet compressor 118. The pressure, and therefore the density, of the pressurized oxidant feed 312 exiting the blower 310 is maintained at a constant level by a variable frequency driver 314 used in conjunction with the blower 310. In this manner, the blower 310 provides varying degrees of compression depending upon the conditions of the feed oxidant 120 in order to achieve the desired constant density of pressurized oxidant feed 312. For example, on warm days or when the oxidant feed 120 is otherwise at a comparatively high temperature, the variable frequency driver 314 may be adjusted so that the blower 310 provides more compression than on cold days or when the oxidant feed 120 is at a comparatively low temperature. The variable frequency driver 314 may be adjusted manually or automatically. It will be apparent to those skilled in the art that sensors or other devices (not shown) may be required to monitor the changing conditions and properties of the oxidant feed 120 so that the variable frequency driver may be adjusted accordingly. Upon exiting the blower 310, pressurized oxidant feed 312 is directed to the inlet compressor 118, and the remainder of the system 300 operates in the same fashion as the system 100 of FIG. 1 described previously.

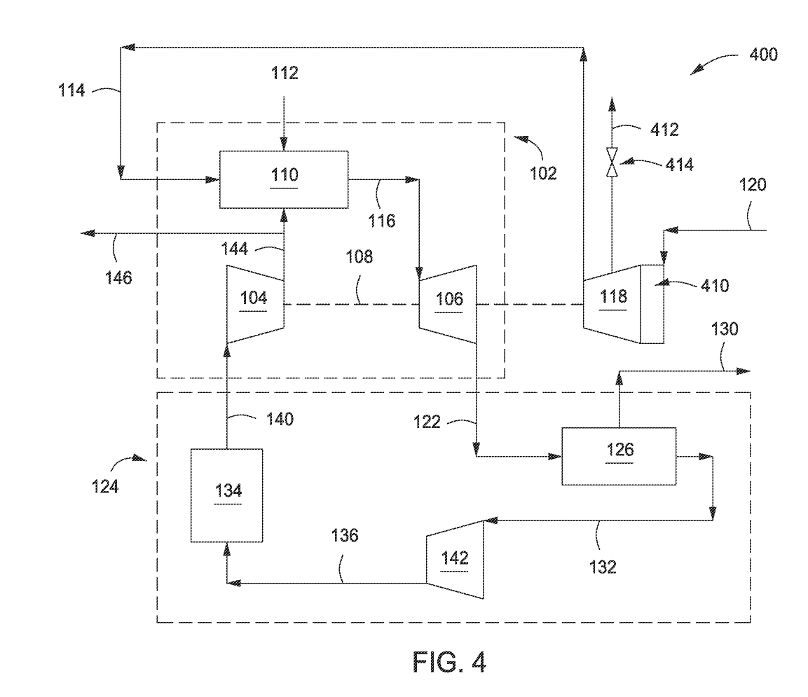

Referring now to FIG. 4, depicted is an alternative configuration of the power generation system 100 of FIG. 1, embodied and described as system 400. As such, FIG. 4 may be best understood with reference to FIG. 1. In system 400 of FIG. 4, inlet guide vanes 410 are added to the first stage of the inlet compressor 118 to control the mass flow rate of oxidant through the inlet compressor 118. The inlet guide vanes 410 may be stationary or variable, but are preferably variable so that they may be adjusted to account for variations in the oxidant feed 120. The inlet guide vanes 410 allow for coarse control of the mass flow rate through the inlet compressor 118, and the operating point of the inlet compressor 118 should be designed so that the lower end of the control accuracy of the inlet guide vanes 410 will provide sufficient air to the combustion chamber 110. For example, if the inlet guide vanes are accurate to within 2%, then 2% additional oxidant should be compressed. In one or more embodiments, fine control over the oxidant flow may be exercised by incorporating a vent stream 412 from the compressor that employs a blowdown valve 414 to vent excess oxidant, if any, before the compressed oxidant 114 is fed to the combustion chamber 110. In such embodiments, the excess oxidant may optionally be vented at a pressure that is less than the discharge pressure of the inlet compressor 118. The remainder of the system 400 operates in the same fashion as the system 100 of FIG. 1 described previously. While it is preferred that the vent stream 412 and blowdown valve 414 are used in conjunction with the inlet guide vanes 410 to provide a maximum amount of control, in one or more alternate embodiments the vent stream 412 and blowdown valve 414 may optionally be employed in place of the inlet guide vanes as the only method of flow control in the inlet compressor 118.

In addition to the embodiments described above and illustrated by FIGS. 2 through 4, additional systems and methods for controlling the supply of oxidant to the combustion chamber to maintain stoichiometric combustion conditions are also contemplated herein, and one or more such options may be implemented separately or in combination with one or more of the previously described embodiments. For example, in a manner similar to that described above with respect to FIG. 2, the oxidant feed may be heated rather than cooled to maintain a constant density. In the same or other embodiments, air orifices within the system may have variable geometry to adjust air flow. In further embodiments, one or more discharge coolers with optional bypass control may be employed to control the temperature of the oxidant feed exiting the inlet compressor and entering the combustor.

In one or more additional embodiments, the system may be designed to run slightly oxygen rich, so that a decrease in ambient air density may be accommodated. In such designs, when the ambient air is more dense, duct burning, a catalyst, or another similar option may be necessary to remove excess oxygen from the system.

In the same or other embodiments, variable drives may be employed throughout the system in a manner similar to that described in FIG. 3. For example, a variable driver may be employed in conjunction with the EGR blower 142, or on the inlet compressor 118 itself In one or more embodiments, a steam driver may be used to operate the inlet compressor 118 so that the speed of the compressor can be varied, thus permitting direct control of the compressor.

While the present disclosure may be susceptible to various modifications and alternative forms, the exemplary embodiments discussed above have been shown only by way of example. Any features or configurations of any embodiment described herein may be combined with any other embodiment or with multiple other embodiments (to the extent feasible) and all such combinations are intended to be within the scope of the present invention. Additionally, it should be understood that the disclosure is not intended to be limited to the particular embodiments disclosed herein. Indeed, the present disclosure includes all alternatives, modifications, and equivalents falling within the true spirit and scope of the appended claims.

What is claimed is:

1. An integrated system comprising:
a gas turbine system comprising a combustion chamber configured to combust one or more oxidants and one or more fuels in the presence of a compressed recycle stream, wherein the combustion chamber directs a first discharge stream to an expander to generate a gaseous exhaust stream and at least partially drive a main compressor;
an inlet compressor configured to compress the one or more oxidants and direct a compressed oxidant stream to the combustion chamber; and
an exhaust gas recirculation system, wherein the main compressor compresses the gaseous exhaust stream and thereby generates the compressed recycle stream;
wherein the reaction conditions in the combustion chamber are stoichiometric or substantially stoichiometric.

2. The system of claim 1, further comprising one or more cooling devices configured to cool the one or more oxidants before introduction to the inlet compressor.

3. The system of claim 2, wherein the one or more oxidants are cooled to a temperature at least about 20° F. lower than ambient conditions.

4. The system of claim 2, further comprising a separator configured to receive the cooled oxidant from the cooling device and remove water droplets from the oxidant stream before introduction to the inlet compressor.

5. The system of claim 2, wherein the cooling device is a heat exchanger using a refrigerant as a cooling fluid.

6. The system of claim 1, further comprising a blower configured to increase the pressure of the one or more oxidants before introduction to the inlet compressor.

7. The system of claim 6, wherein the blower is controlled by a variable frequency driver.

8. The system of claim 1, wherein the inlet compressor comprises inlet guide vanes.

9. The system of claim 8, wherein the inlet compressor further comprises a vent stream with a valve configured to release excess oxidant from the inlet compressor.

10. The system of claim 9, wherein the valve is configured to release the excess oxidant from the inlet compressor at a pressure that is less than the discharge pressure of the inlet compressor.

11. A method of generating power, comprising:
compressing one or more oxidants in an inlet compressor to form a compressed oxidant;
combusting the compressed oxidant and at least one fuel in a combustion chamber in the presence of a compressed recycle exhaust gas, thereby generating a discharge stream;
expanding the discharge stream in an expander to at least partially drive a main compressor and generate a gaseous exhaust stream; and
directing the gaseous exhaust stream to an exhaust gas recirculation system, wherein the main compressor compresses the gaseous exhaust stream and thereby generates the compressed recycle stream;
wherein the reaction conditions in the combustion chamber are stoichiometric or substantially stoichiometric.

12. The method of claim 11, further comprising cooling the one or more oxidants in a cooling device before introducing the one or more oxidants to the inlet compressor.

13. The method of claim 12, wherein the one or more oxidants are cooled to a temperature at least about 20° F. lower than ambient conditions.

14. The method of claim 12, further comprising receiving cooled oxidant from the cooling device and removing water droplets from the cooled oxidant in a separator before introducing the oxidant to the inlet compressor.

15. The method of claim 12, wherein the cooling device is a heat exchanger using a refrigerant as a cooling fluid.

16. The method of claim 11, further comprising increasing the pressure of the one or more oxidants using a blower before introducing the oxidant to the inlet compressor.

17. The method of claim 16, wherein the blower is controlled by a variable frequency driver.

18. The method of claim 11, wherein the inlet compressor comprises inlet guide vanes.

19. The method of claim 18, further comprising venting excess oxidant from the inlet compressor.

20. The method of claim 19, wherein the excess oxidant is vented from the inlet compressor at a pressure that is less than the discharge pressure of the inlet compressor.

21. The system of claim 1, wherein the compressed recycle stream includes a steam coolant, which supplements or replaces the gaseous exhaust stream.

22. The system of claim 21, further comprising a water recycle loop to provide the steam coolant.

23. The method of claim 11, further comprising adding a steam coolant to the compressed recycle stream to supplement or replace the gaseous exhaust stream.

24. The method of claim 23, further comprising a water recycle loop to provide the steam coolant.
